(19) United States
(12) Patent Application Publication
(10) Pub. No.: US 2006/0071940 A1
(43) Pub. Date: Apr. 6, 2006

(54) Correction data setting method and manufacturing method of image display apparatus

(75) Inventor: Akihiro Ouchi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/238,959

(22) Filed: Sep. 30, 2005

(30) Foreign Application Priority Data
Oct. 1, 2004 (JP) 2004-290067
Sep. 16, 2005 (JP) 2005-269883

(51) Int. Cl. G09G 5/02

(52) U.S. Cl. 345/600

(57) ABSTRACT

In a correction data generating method for use with an image display apparatus having data conversion means for outputting digital data of corrected image signal with respect to digital data of R, G and B input image signals, tristimulus values of R, G and B are obtained at or near a maximum gradation value, and tristimulus values for those color component signals are also obtained at those signals' respective minimum gradation value. Also obtained are tristimulus values when R, G and B are displayed at the same time at a gradation value between those two gradation values, and there is generated a conversion matrix for converting XYZ (constituted of difference values obtained by subtracting the second from the first tristimulus values) to a color mixture ratio of R, G, and B. A color mixture ratio of R, G and B is calculated from the generated conversion matrix and the third measured tristimulus values, and correction data is generated from (i) change characteristic data corresponding to a relation between an input gradation value and a color mixture ratio of the R, G and B calculated corresponding to the input gradation value and (ii) a target gradation characteristic data corresponding to a relation between the input gradation value and brightness data corresponding to the input gradation value.

### BACKGROUND OF THE INVENTION

1. Field of the Invention

The present invention relates to a correction data setting method for correcting gradation and white balance in an image display apparatus and a manufacturing method of the image display apparatus, and more particularly to a correction data setting method for correcting dispersion in voltage-transmissivity characteristic of every liquid crystal device and in a liquid crystal device plane of a 3-piece type liquid crystal projector.

2. Description of the Related Art

Because in a liquid crystal display unit which is an image display unit, transmissivity (T) characteristic to an input voltage (V), so-called V-T characteristic is non-linear, that characteristic needs to be corrected to linear characteristic. Further, because it is premised that the image signal is displayed on a CRT display, that image signal has an inverted γ characteristic for compensating for the non-linear display characteristic of the CRT. Thus, the liquid crystal display unit corrects the non-linear V-T characteristic of the liquid crystal and the inverted γ characteristic of an image signal and generally, these gradation corrections are called γ correction.

According to one of conventional units for executing automatic adjustment method for the γ correction and the γ correction, by measuring output brightness while controlling the voltage applied to the liquid crystal panel for each color of red (R), green (G) and blue (B) the V-T characteristic is obtained. And the γ correction data of a liquid crystal panel corresponding to each color is calculated based on the obtained V-T characteristic. And then, a calculated γ correction data is memorized in a nonvolatile memory which is a composition element of the unit for executing the γ correction (for example, see Japanese Patent Application Laid-Open No. 5-64037).

Further, color tone (white balance) is an important element for high quality image display and according to some proposal, the γ correction data considering the white balance is generated using the chromaticity measurement data of R, G and B and the V-T characteristic data (for example, see Japanese Patent Application Laid-Open No. 11-355798).

The conventional technology will be explained with reference to FIG. 9. Referring to FIG. 9, reference numerals 101, 102, 103 denote light volume adjustment unit for R, G and B, which adjust the light volume of a R light source 118, a G light source 119 and a B light source 120 independently. Reference numeral 110 denotes color synthesis unit, which synthesizes R, G and B lights adjusted by the light volume adjustment unit 101, 102, 103 so as to generate a display image 117. Reference numerals 104, 105, 106 denote correction data storage unitfor R, G and B, whichcorrects R, G and B imagesignals 111, 112, 113 inputted as an address signal using preliminarily stored correction data so as to output to the light volume adjustment unit 101, 102, 103 as correction image signals 114, 115, 116.

Each of chromaticity measurement value of R, G and B adjusted with the light volume adjustment unit 101, 102, 103 with respect to a predetermined correction image signal 114, 115, 116 is handled as a chromaticity measurement data, and a value obtained by measuring brightness of each of R, G and B passing through the light volume adjustment unit 101, 102, 103 by changing the value of the correction image signal 114, 115, 116 is handled as V-T characteristic measurement data.

White display synthesis brightness ratio Rratio_w, Gratio_w and Bratio_w are calculated according to a formula (1) and a formula (2) from the chromaticity of R, G and B obtained from the chromaticity measurement data and white display target chromaticity (=white balance).

The formulas (1) and (2) are as follows:

$$Formula ( 1 ) \\ \frac{Yr}{Yg} = \frac{- ( Wx\_w - Gx ) ( Wy\_w - By ) + ( Wx\_w - Bx ) ( Wy - Gy )}{( Wx\_w - Rx ) ( Wy\_w - By ) + ( Wx\_w - Bx ) ( Wy - Ry )} \times \frac{Ry}{Gy} \\ \frac{Yb}{Yg} = \frac{- ( Wx\_w - Gx ) ( Wy\_w - Ry ) + ( Wx\_w - Rx ) ( Wy - Gy )}{( Wx\_w - Bx ) ( Wy\_w - Ry ) + ( Wx\_w - Rx ) ( Wy - By )} \times \frac{By}{Gy} \qquad ( 1 )$$

Where:
Yr, Yg, Yb: brightness of R, G, B
Wx_w, Wy_w: x, y chromaticity coordinates of target white display
Rx, Ry: x, y chromaticity coordinate of R
Gx, Gy: x, y chromaticity coordinate of G
Bx, By: x, y chromaticity coordinate of B

$$Formula ( 2 ) \\ Rratio\_w = \frac{100 \times ( Yr / Yg )}{( Yr / Yg ) + 1 + ( Yb / Yg )} \\ Gratio\_w = \frac{100}{( Yr / Yg ) + 1 + ( Yb / Yg )} \\ Bratio\_w = \frac{100 \times ( Yb / Yg )}{( Yr / Yg ) + 1 + ( Yb / Yg )} \qquad ( 2 )$$

Where: p1 Yr, Yg, Yb: brightness of R, G and B
Rratio_w: white display synthesis brightness ratio of R
Gratio_w: white display synthesis brightness ratio of G
Bratio_w: white display synthesis brightness ratio of B

Next, a ratio of maximum brightness to the white display synthesis brightness ratio of each color is calculated from this white display synthesis brightness ratio and the maximum brightness of R, G and B obtained from the V-T characteristic measurement data and then, correction maximum brightness Y′ r_max, Y′ g_max, Y′ b_max of R, G and B in a target white display are determined.

In case of black display, a black display synthesis brightness ratio is calculated from the white display and black display target chromaticity and a ratio of minimum brightness to the black display synthesis brightness ratio is calculated from this black display synthesis brightness ratio and minimum brightness of R, G and B obtained from the V-T characteristic measurement data and then, correction minimum brightness Y′ r_min, Y′ g_min, Y′_b min of R, G and B in a target black display are determined.

Next, a gradation function f(x) (0≦f(x)≦1, 0≦x≦2ⁿ) indicating the gradation characteristic of brightness of after correction to an image signal x is set up and a target brightness function (formula (3)) which determines brightness y′ r, y′ g, y′ b after correction of R, G and B are generated from the correction maximum brightness and correction minimum brightness.

The formula (3) is as follows:

$$Formula ( 3 ) \\ {y}^{′} r = ( {Y}^{′} r\_max - {Y}^{′} r\_min ) \times f ( x ) + {Y}^{′} r\_min \\ {y}^{′} g = ( {Y}^{′} g\_max - {Y}^{′} g\_min ) \times f ( x ) + {Y}^{′} g\_min \\ {y}^{′} b = ( {Y}^{′} b\_max - {Y}^{′} b\_min ) \times f ( x ) + {Y}^{′} b\_min \qquad ( 3 )$$

Where:
Y′ r_max, Y′ g_max, Y′ b_max: correction maximum brightness of R, G and B
Y′ r_min, Y′ g_min, Y′ b_min: correction minimum brightness of R, G and B
f(x): gradation function

Data to be stored in the correction data storage unit 104, 105, and 106 are generated from the target brightness function and the V-T characteristic measurement data generated in this way.

### SUMMARY OF THE INVENTION

Although according to generation technology of the γ correction data taking into account the above-described white balance, a target color mixture ratio of R, G and B is obtained from the chromaticity of actually measured R, G and B for a predetermined correction image signal 114, 115, 116 when the white balance is adjusted, an influence of lightening of black tone possessed by a liquid crystal device at a low gradation value below an intermediate gradation value is not considered.

The lightening of black tone possessed by the liquid crystal device unit having some degree of brightness and chromaticity when with the liquid crystal device made to display a minimum gradation value, brightness and chromaticity are measured. This indicates that brightness components of R, G and B always exist although a slight amount and unit that the chromaticity changes depending on the gradation value even if R, G and B are displayed in a single color.

According to a conventional technology, a target brightness of R, G and B in other gradation range is determined using correction maximum brightness and correction minimum brightness obtained from a target color mixture ratio calculated in white display (=maximum gradation value) and a target color mixture ratio calculated in black display (=minimum gradation value). However because in determining a target brightness in an intermediate gradation value, any change in chromaticity of each of R, G and B originating from lightening of black tone possessed by the liquid crystal device is not considered, dispersion occurs in color mixture ratio of each of R, G and B when R, G and B are synthesized and as a consequence, dispersion occurs in chromaticity in the intermediate gradation value.

Although the image display apparatus is preferred to be capable of changing displays on plural white balances depending on user's taste or usage environment, the conventional technology needs to generate correction data for each of the plural white balances.

The present invention has been achieved in views of such problems of the conventional technology and an object of the invention is to provide a technology enabling display generating no dispersion in chromaticity in an intermediate gradation value and without any dispersion in chromaticity over an entire gradation range, this technology enabling display to be carried out at an arbitrary white balance without necessity of plural correction data or changing the correction data.

To achieve the above-described object, the present invention adopts following configuration.

According to the present invention, there is provided a correction data setting method of an image display apparatus having a data conversion unit for outputting digital data of corrected image signal to digital data of each input image signal of R, G and B, comprising:

a first step of obtaining tristimulus values of each of R, G and B at a maximum gradation value or a gradation value near the maximum gradation value;

a second step of obtaining tristimulus values when R, G and B at the minimum gradation value are displayed at the same time;

a third step of obtaining tristimulus values when R, G and B are displayed between the maximum gradation value or a gradation value near the maximum gradation value and the minimum gradation value at the same time;

a generating step of generating a conversion matrix for converting XYZ, constituted of tristimulus values obtained by subtracting the tristimulus values obtained in the second step from the tristimulus values of each of R, G and B obtained in the first step, to RGB;

a calculating step of calculating a color mixture ratio of R, G and B from generated the conversion matrix and the tristimulus values obtained in the third step;

a generating step of generating correction data from (i) change characteristic data including an input gradation value and a color mixture ratio of the R, G and B calculated corresponding to the input gradation value and (ii) a target gradation characteristic data including the input gradation value and brightness data corresponding to the input gradation value; and

a storing step of storing the generated correction data in the data conversion unit.

Moreover, according to the present invention, there is provided a manufacturing method of image display apparatus comprising:

an assembling step of assembling an image display apparatus having a data conversion unit for outputting digital data of correction image signal to digital data of each input image signal of R, G and B;

a first step of obtaining tristimulus values of each of R, G and B at a maximum gradation value or a gradation value near the maximum gradation value;

a second step of obtaining tristimulus values when R, G and B at the minimum gradation value are displayed at the same time;

a third step of obtaining tristimulus values when R, G and B are displayed between the maximum gradation value or a gradation value near the maximum gradation value and the minimum gradation value at the same time;

a generating step of generating a conversion matrix for converting XYZ constituted of tristimulus values obtained by subtracting the tristimulus values obtained in the second step from the tristimulus values of each of R, G and B obtained in the first step to RGB;

a calculating step of calculating a color mixture ratio of R, G and B from the generated conversion matrix and the tristimulus values obtained in the third step;

a generating step of generating correction data from (i) change characteristic data including an input gradation value and a color mixture ratio of the R, G and B calculated corresponding to the input gradation value and a target gradation characteristic data including the input gradation value and brightness data corresponding to the input gradation value; and

a setting step of setting generated the correction data in a memory which is the data conversion unit.

### DESCRIPTION OF THE DRAWINGS

FIG. 1 is a schematic block diagram showing a liquid crystal display unit using the gradation correction method according to a first embodiment of the invention;

FIG. 2 is a flow chart showing a processing to be executed by the gradation correction method according to the first embodiment of the invention;

FIG. 3 is a diagram showing a change characteristic of color mixture ratio to input gradation value;

FIG. 4 is a diagram showing the relation between the change characteristic of a target color mixture ratio, the change characteristic of color mixture ratio of a image display unit and γ correction characteristic;

FIG. 5 is a flow chart showing a processing to be executed by the gradation correction method according to a second embodiment of the invention;

FIG. 6 is a schematic block diagram of correction data automatic setting system in a liquid crystal display unit according to a third embodiment of the invention;

FIG. 7 is a schematic block diagram showing a liquid crystal display unit according to a fourth embodiment of the invention;

FIG. 8 is a schematic block diagram showing a γ correction data generation unit according to the fourth embodiment of the invention; and

FIG. 9 is a schematic block diagram showing a liquid crystal display unit using a conventional gradation correction method.

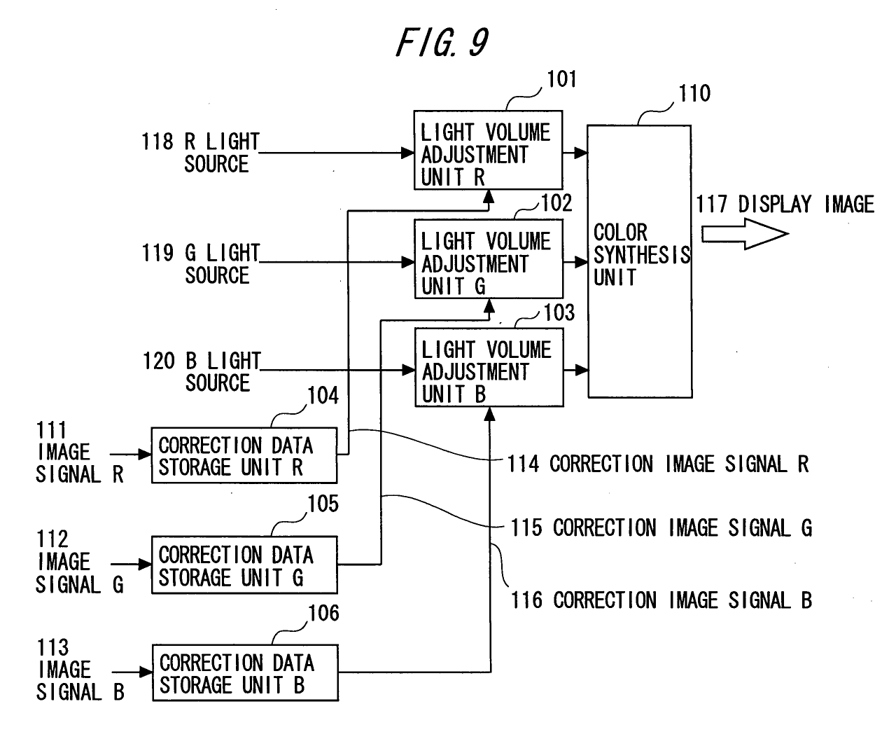

### DETAILED DESCRIPTION OF THE INVENTION

Hereinafter, the preferred embodiments of the present invention will be exemplary described in detail with reference to the accompanying drawings. The dimensions, material, shape and relative arrangement of components described in this embodiment do not restrict the scope of the invention to any particular ones unless specified otherwise.

### First Embodiment

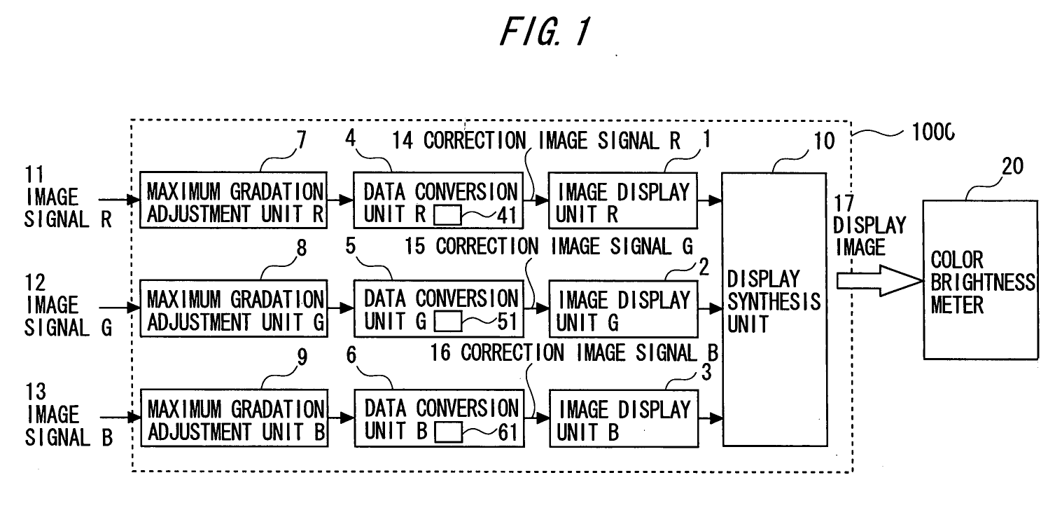

FIG. 1 is a block diagram showing a schematic structure of a liquid crystal display apparatus 1000 which is an image display unit according to a first embodiment of the invention.

In FIG. 1, reference numerals 1, 2, 3 denote an image display unit such as a liquid crystal display panel for red (R), green (G) and blue (B) and reference numeral 10 denotes a display synthesis unit, which synthesizes displays corresponding to R, G and B displayed by the image display unit 1, 2, 3 optically so as to generate a displayed image.

Reference numerals 4, 5, 6 denote a data conversion unit for R, G and B, which uses γ correction data as a preliminarily stored gradation correction data so as to output input image signals 11, 12, 13 to the image display unit 1, 2, 3 as correction image signals 14, 15, 16.

Reference numerals 7, 8, 9 denote maximum gradation value adjustment unit for R, G and B, which adjusts the maximum gradation value by applying a gain to the input image signals 11, 12, 13.

The image display apparatus can be manufactured by connecting the maximum gradation value adjustment unit 7, 8, 9, the data conversion unit 4, 5, 6 and the image display unit 1, 2, 3 electrically, assembling so as to synthesize output images from the image display unit 1, 2, 3 optically by the display synthesis unit 10. The display synthesis unit 10 can be realized according to a well known method used in a liquid crystal projector, a rear projection type TV and the like.

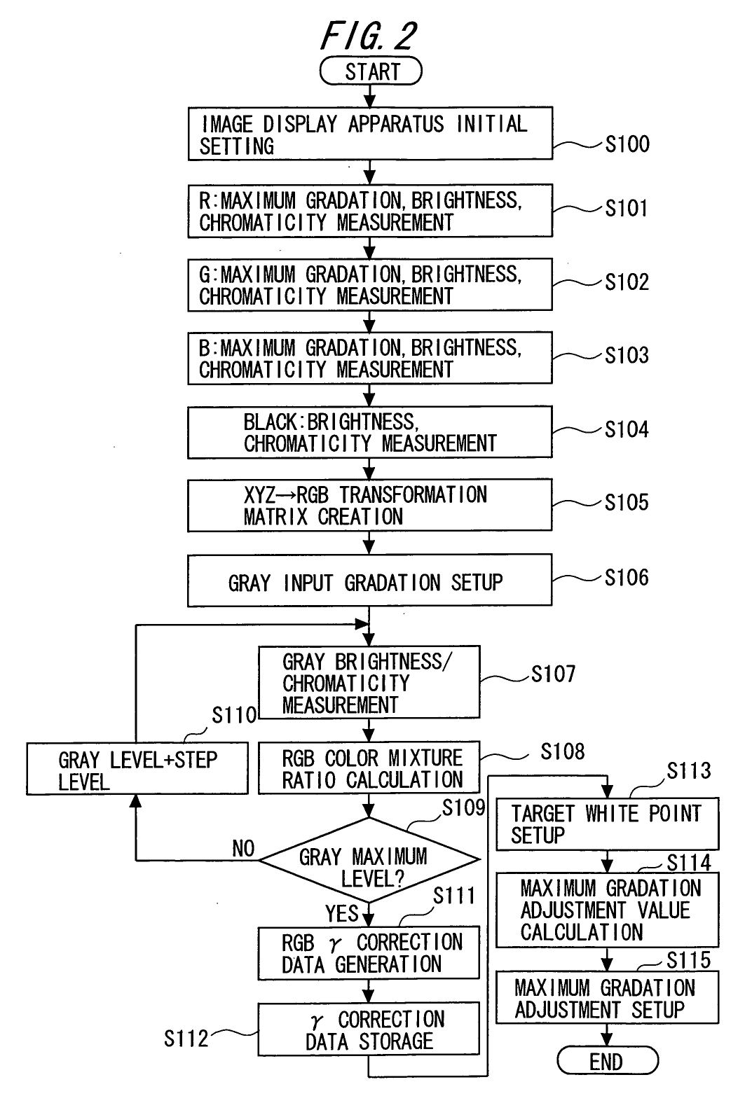

In this liquid crystal display apparatus 1000, γ correction data is generated according to a flow chart shown in FIG. 2.

To measure the device characteristic of the image display unit 1, 2, 3 which is a liquid crystal display panel, the input image signals 11, 12, 13 are supplied to the maximum gradation value adjustment unit 7, 8, 9 and the data conversion unit 4, 5, 6 and set up so that the input image signals 11, 12, 13 turn to correction image signals 14, 15, 16. This is an initial setting of a liquid crystal display apparatus 1000 (step S100).

Next, with display of R as maximum gradation value (1023) and displays of G and B as minimum gradation value (0), brightness and chromaticity of R at the maximum gradation value are measured with a color brightness meter 20 (step S101). Further, with display of G as maximum gradation value and displays of R and B as minimum gradation value, brightness and chromaticity of G at the maximum gradation value are measured with the color brightness meter 20 (step S102) Further, with display of B as maximum gradation value and displays of R and Gas minimum gradation value, brightness and chromaticity of B at the maximum gradation value are measured with the color brightness meter 20 (step S103). Next, with displays of R, G and B as minimum gradation value (=black display), brightness and chromaticity of black display are measured with the color brightness meter 20 (step S104).

In steps S101-S103, it is permissible to measure brightness and chromaticity at a gradation value near the maximum gradation value instead of the maximum graduation level (1023). For example, the gradation value near the maximum gradation value is assumed to be smaller than the maximum gradation value and over maximum gradation value x 0.95 (=971.85). In this case, the gradation value near the maximum gradation value is equal to or more than 972 to less than 1023.

A XYZ-RGB conversion matrix is created from brightness and chromaticitymeasured in steps S101-S104 (step S105).

The creation of XYZ-RGB conversion matrix is based on the following way. Brightness and chromaticity measurement data is Yxy color specification system, and can be converted into data of XYZ color specification system using the formula (4). The formula (4) is as follows:

$$Formula ( 4 ) \\ X = \frac{x}{y} Y \\ Y = Y \\ Z = \frac{1 - x - y}{y} Y \qquad ( 4 )$$

Y: brightness data
x, y: chromaticity coordinates
X, Y, Z: tristimulus values

Image signals inputted to the image display unit correspond to color mixture ratio of RGB display color system and a relation expressed by a formula (5) exists between the RGB display color system and XYZ display color system.

The formula (5) is as follows:

$$Formula ( 5 ) \\ [ \begin{matrix}{X}^{′} \\ {Y}^{′} \\ {Z}^{′}\end{matrix} ] = M [ \begin{matrix}R \\ G \\ B\end{matrix} ] , M = [ \begin{matrix}Xr & Xg & Xb \\ Yr & Yg & Yb \\ Zr & Zg & Zb\end{matrix} ] \qquad ( 5 )$$

Where:
Xr, Yr, Zr: tristimulus values of R in maximum gradation value display
Xg, Yg, Zg: tristimulus values.of G in maximum gradation display
Xb, Yb, Zb: tristimulus values of B in maximum gradation display
X′, Y′, Z′: tristimulus values of synthesis color of R, G, and B
R, G, B: color mixture ratio of R, G and B

A RGB color mixture ratio for displaying any tristimulus values X′, Y′, Z′ from the formula (5) can be obtained according to the formula (6).

The formula (6) is as follow:

$$Formula ( 6 ) \\ [ \begin{matrix}R \\ G \\ B\end{matrix} ] = {M}^{- 1} [ \begin{matrix}{X}^{′} \\ {Y}^{′} \\ {Z}^{′}\end{matrix} ] \qquad ( 6 )$$

M⁻¹ in the formula (6) is XYZ-RGB conversion matrix and by determining this XYZ-RGB conversion matrix, a RGB color mixture ratio can be calculated from the tristimulus values expressed in arbitrary gray.

If all the displays of R, G and B are executed at the minimum gradation value (black display), lights of R, G and B always exist (lightening of black tone) although they are in a fine amount. Therefore, a substantial display corresponding to an input gradation value can be considered to be a value obtained by subtracting the tristimulus values of black display.

Then, considering influences of lightening of black tone, the XYZ-RGB conversion matrix (M-¹) is expressed as a formula (7).

The formula (7) is as follows:

$$Formula ( 7 ) \\ {M}^{- 1} = [ \begin{matrix}Xr - Xbk & Yr - Ybk & Zr - Zbk \\ Xg - Xbk & Yg - Ybk & Zg - Zbk \\ Xb - Xbk & Yb - Ybk & Zb - Zbk\end{matrix} ] \qquad ( 7 )$$

Where Xbk, Ybk, Zbk are tristimulus values in minimum gradation value display of R, G and B.

Next, all the displays of R, G and B are executed at a predetermined equal gradation value (=displayed in gray) (step S106) and brightness and chromaticity of gray display are measured with the color brightness meter 20 (step S107). Next, a RGB color mixture ratio is calculated using the formula (6) from the tristimulus values of gray display (step S108). The XYZ-RGB conversion matrix (M⁻¹) of the formula (6) used in step S108 is XYZ-RGB conversion matrix (M⁻¹) expressed in the formula (7). Then, whether or not a currently expressed gray display is at a maximum gradation value is determined (step S109) and unless it is at the maximum gradation value, the gradation value is changed by a predetermined gradation amount (=step level) (step S110) and step S107 to step S110 are repeated until the display gradation value reaches a maximum gradation value.

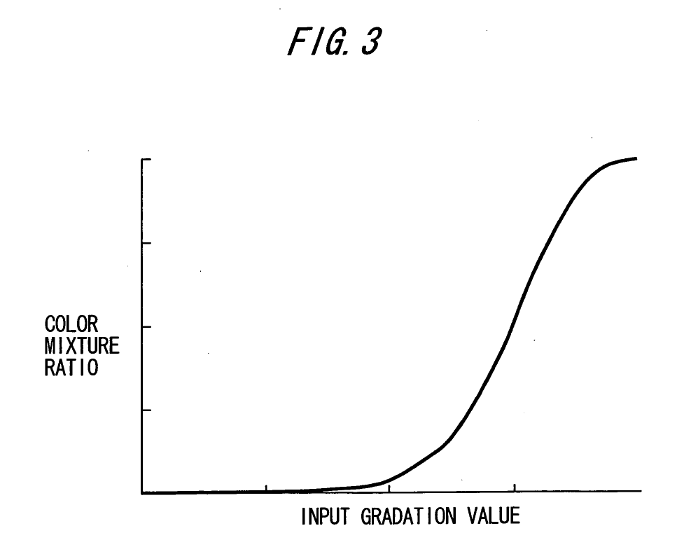

From a series of flow in steps S100-S110, a change characteristic of color mixture ratio of R, G and B corresponding to an input gradation value based on the V-T characteristic is obtained as shown in FIG. 3.

In the meantime, the changing gradation amount in step S110 is permitted to be an equal interval or dense in a region in which the change ratio of the V-T characteristic is small. Although the gradation value is changed from low gradation value to the maximum gradation value here, it may be changed from the maximum gradation value to the low gradation value or changed at random because an object here is to acquire data covering entire gradation regions.

Then, γ correction data is generated according to the change characteristic of color mixture ratio of R, G and B to such an obtained input gradation value (step S111) and the data is stored in memory unit 41, 51, 61 constitutiing the data conversion unit 4, 5, 6 (step S112).

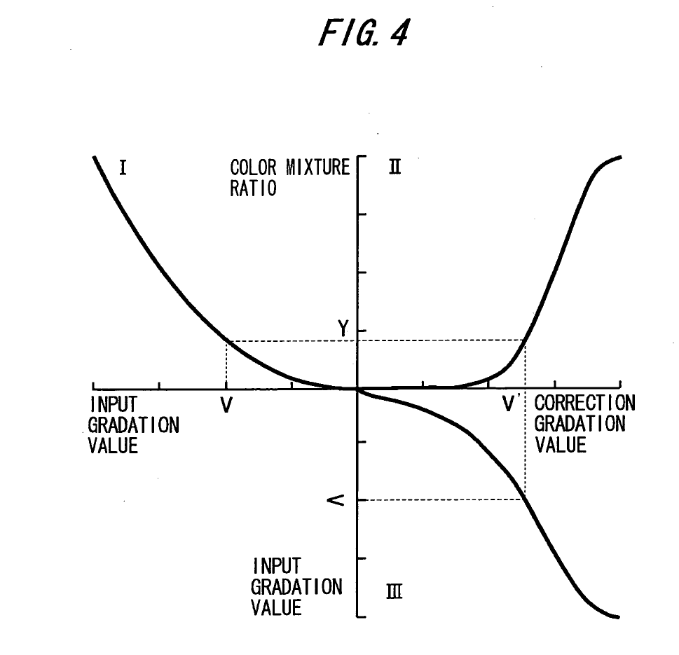

The γ correction data is obtained as LUT data for converting the change characteristic (change characteristic data) of color mixture ratio to a change characteristic (target gradation characteristic data) used as a target. The relation between the change characteristic data and the target gradation characteristic data is as shown in FIG. 4. In FIG. 4, a region I indicates a change characteristic of an output brightness expectedwith respect to input gradation value and generally, if the input gradation value is assumed to be V, this is expressed as f(V)=V^{γ}. A value of γ of the characteristic is e.g. “2.2” when a display based on NTSC signals is executed. A region II indicates a characteristic accordant with the V-T characteristic shown in FIG. 3. A region III indicates γ correction characteristic.

For example, in the target change characteristic in the region I, when the input gradation value is V, the target mixture ratio is Y. It is apparent that a correction gradation value to the liquid crystal display panel to be required to obtain the mixture ratio Y should be V′ from a characteristic shown in the region II. Accordingly, in order to obtain the target change characteristic, it is necessary to convert the input gradation value V to V′. The change characteristic is γ correction characteristic shown in the region III.

As mentioned above, it is apparent that γ correction characteristic can be obtained as an inverse function of the characteristic accordant with V-T characteristic, replaced the mixture ratio with the input gradation value. That is, a function corresponding to the characteristic shown in the region III is the inverse function of “a function for converting the input gradation value to the mixture ratio (brightness of R, brightness of G or brightness of B), and further converting the mixture ratio to the correction gradation value (conversion corresponding to the region II)”. In addition, since sampling points for measuring the change characteristic of color mixture ratio is discrete, the γ correction characteristics is obtained by interpolation calculation using linear interpolation, spline interpolation or the like.

Next, the chromaticity coordinate of a target white point is set up (step S113) and a maximum gradation adjustment value is determined based on RGB color mixture ratio for obtaining a target white point calculated from the formula (6) (step S114) and this is set up as an adjustment value for the maximum gradation adjustment unit 7, 8, 9 (step S115). In step S114, the ratio of other color to the color which occupies a maximum ratio of the calculated RGB color mixture ratio is calculated as a maximum gradation adjustment value.

Although according to this embodiment, the tristimulus values XYZ are calculated from measurement values of brightness and chromaticity of each display, it is permissible to use a result of measurement of the brightness and chromaticity of each display as direct tristimulus values.

As described above, according to this embodiment, gradation display can be carried out with a RGB color mixture ratio constant with respect to lightening of black tone existing in the minimum gradation display of a liquid crystal device. As a consequence, no dispersion in chromaticity occurs in an intermediate gradation value and a display without any dispersion in chromaticity can be achieved in the entire gradation region. Further, because the RGB color mixture ratio over the entire gradation region is constant, any white balance can be displayed only by adjustment of the maximum gradation adjustment unit 7, 8, 9 without a necessity of plural γ correction data and without changing the γ correction data.

### Second Embodiment

The second embodiment includes a second memory unit for storing the γ correction error data as gradation correction error data separately from a first memory unit 41, 51, 61 for storing the γ correction data, which is a composition element of the data conversion unit 4, 5, 6 of the liquid crystal display apparatus 1000 according to the first embodiment.

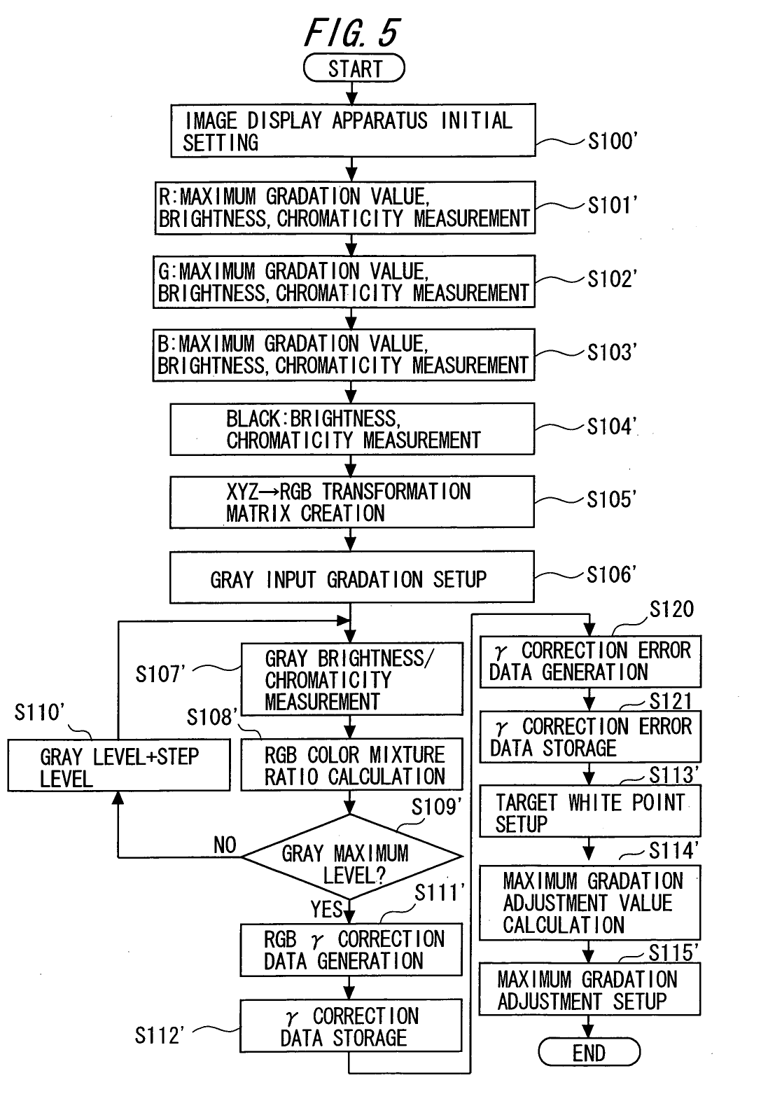

This liquid crystal display apparatus 1000 generates the γ correction data and the γ correction error data according to a flow chart shown in FIG. 5. From step S101′ to step S111′ is the same processing as step S101 to step S111 described in the first embodiment, which is executed in plural regions of a display screen and description thereof is omitted.

Of the γ correction data corresponding to plural regions generated by processing from step S101′ to step S111′, the γ correction data corresponding to a reference region is stored in the first memory region 41, 51, 61 constituting the data conversion unit 4, 5, 6 as representative γ correction data (step S112′).

An error between the γ correction data of the reference region and the γ correction data of other region is generated as a γ correction error data (step S120) and stored in a second memory unit (not shown) constituting the data conversion unit 4, 5, 6 (step S121)

Next, the chromaticity coordinate of a target white point is set up (step S113′) and a maximum gradation adjustment value in the reference region is determined based on RGB color mixture ratio for obtaining a target white point calculated according to the formula (6) (step S114′) and set up as an adjustment value of the maximum gradation adjustment unit 7, 8, 9 (step S115′).

The γ correction error data stored in the second memory unit aims at correcting display ununiformity in a plane originating from the structure or the like of the liquid crystal panel, which is an image display unit. This data is generated discretely to a display area and can be increased to data corresponding to individual pixel by using linear interpolation, spline interpolation or the like.

According to this embodiment, as described above, display without any chromaticity dispersion can be executed on an entire display screen and in all gradation regions.

### Third Embodiment

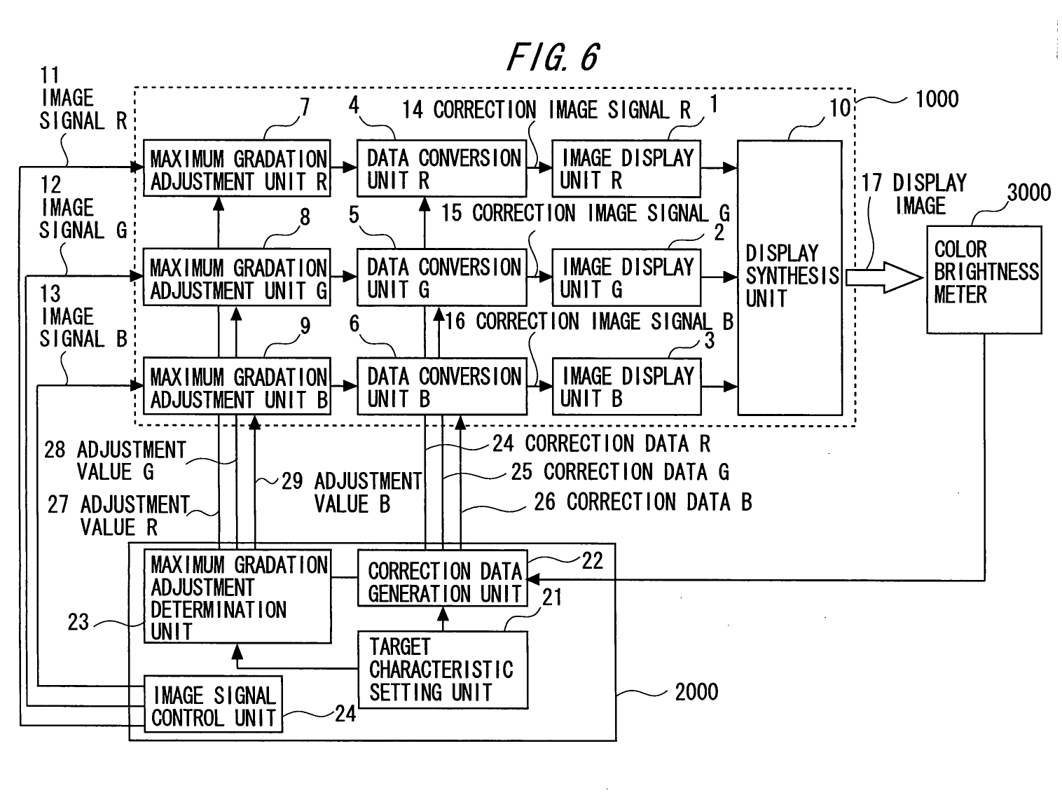

FIG. 6 is a block diagram showing a schematic structure of an automatic setting system for the γ correction data in the liquid crystal display unit according to the third embodiment.

In FIG. 6, the liquid crystal display apparatus 1000 is the same as the liquid crystal display apparatus 1000 of the first embodiment and description thereof is omitted here.

Reference numeral 2000 denotes a γ correction data generation unit, comprising a target characteristic setting unit 21 for setting a target characteristic of the γ correction and white balance, a correction data generation unit 22 for generating the γ correction data, a maximum gradation adjustment value determination unit 23 for adjusting white balance and an image signal control unit 24 for controlling the display gradation of the image signals 11, 12, 13, and generally, this is achieved as an application of a personal computer.

Reference numeral 3000 denotes a color brightness meter 20, which measures the brightness and chromaticity of the display image 17.

In automatic setting system for the γ correction data of this liquid crystal display apparatus 1000, the γ correction data generating unit 2000 generates a maximum gradation adjustment value for adjustment of γ correction data and white balance according to the γ correction method described in the first embodiment and stores and sets each γ correction data and maximum gradation adjustment value in the data conversion unit 4, 5, 6 constituting the liquid crystal display apparatus 1000 and the maximum gradation adjustment unit 7, 8, 9.

Although this embodiment is so constructed that the image signal control unit 24 outputs direct image signal 11, 12, 13 to the liquid crystal display apparatus 1000, it may be so constructed that a desired gradation image signal is outputted to the liquid crystal display apparatus 1000 by controlling a signal generation unit separately or so as to control the gradation image signal generation unit by providing the liquid crystal display apparatus 1000 with a gradation image signal generation unit.

As described above, according to this embodiment, the γ correction data and arbitrary white balance adjustment value can be automatically set up in order to make the RGB color mixture ratio constant with respect to the lightening of black tone existing in the minimum gradation display of a liquid crystal device.

### Fourth Embodiment

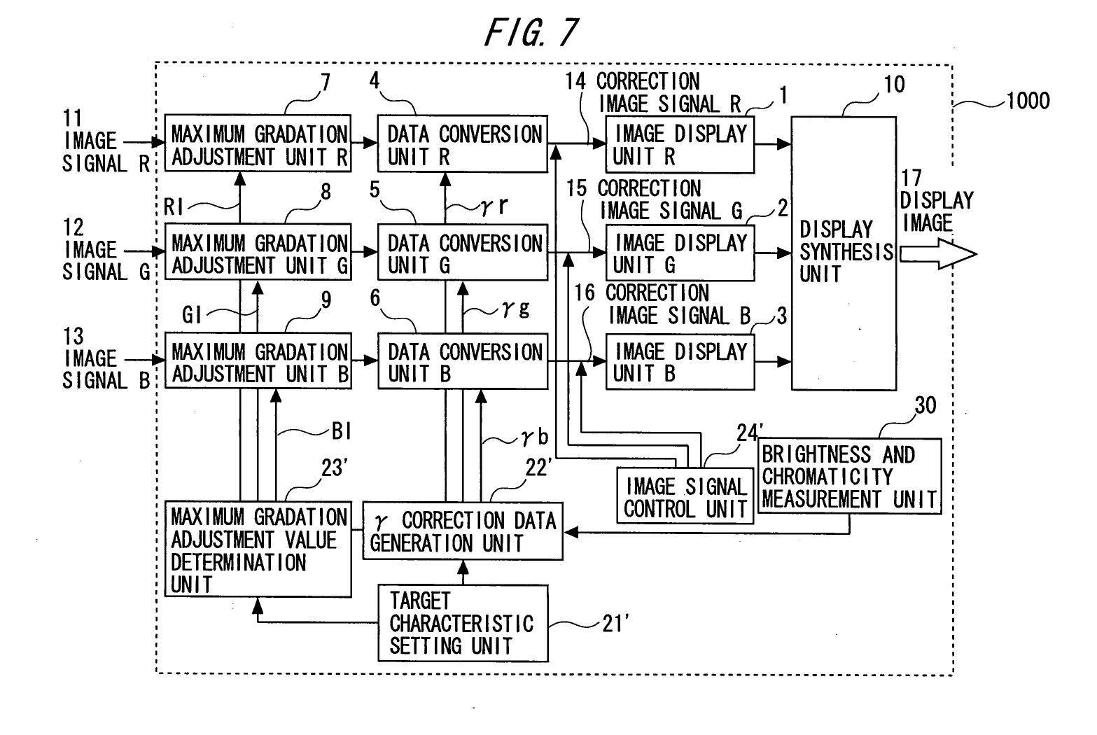

FIG. 7 is a block diagram showing the schematic structure of the liquid crystal display unit according to the fourth embodiment.

In the liquid crystal display apparatus 1000′ shown in FIG. 7, like reference numerals are attached to the same components as the liquid crystal display apparatus 1000 of the first embodiment and description thereof is omitted.

Reference numeral 21′ denotes a target characteristic setting unit for setting a target characteristic of the γ correction and white balance, reference numeral 22′ denotes a γ correction data generation unit for generating the γ correction data, reference numeral 23′ denotes a maximum gradation adjustment value determination unit for adjusting the white balance, reference numeral 24 denotes an image signal control unit for controlling the display gradation of the image signals 11, 12, 13 and reference numeral 30 denotes a brightness and chromaticity measurement unit for measuring the brightness and chromaticity of the display screen.

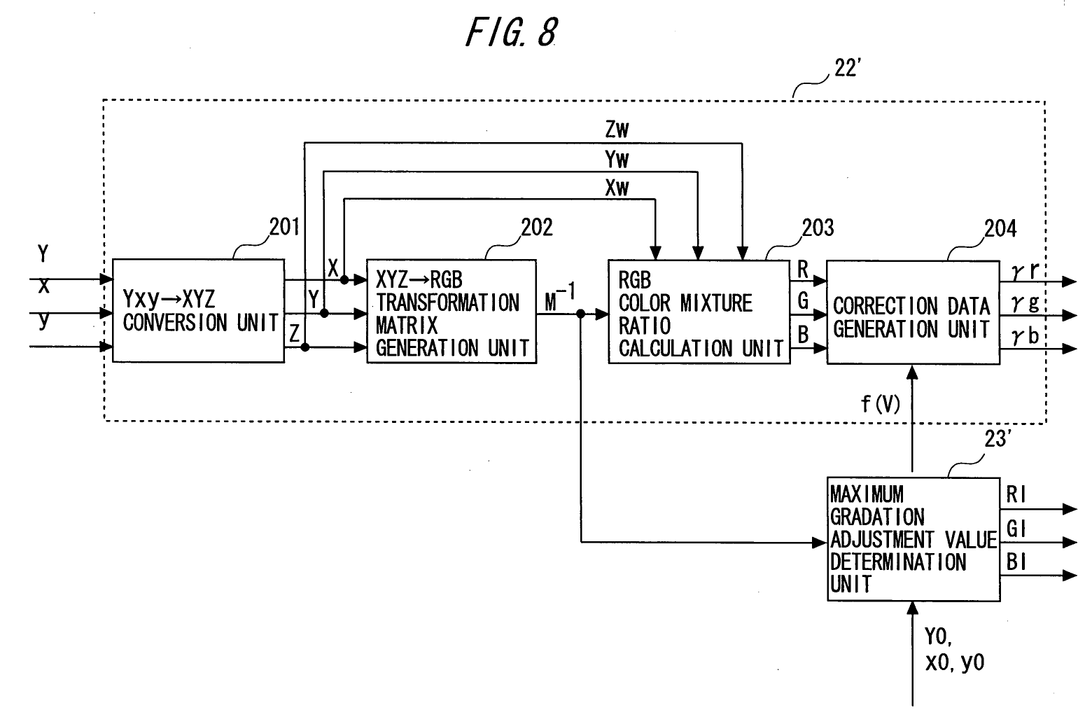

FIG. 8 is a block diagram showing the schematic structure of the γ correction data generation unit 22′. Referring to FIG. 8, reference numeral 201 denotes a Yxy-XYZ conversion unit for converting brightness Y and chromaticity x, y measured by the brightness and chromaticity measurement unit 30 to the tristimulus values X, Y, Z. Reference numeral 202 denotes a XYZ-RGB conversion matrix generation unit for generating an XYZ-RGB conversion matrix from tristimulus values obtained from a measurement value on a screen in which maximum gradation values of R, G and B are displayed individually and tristimulus values obtained from a measurement value on a screen in which the minimum gradation values of R, G and B are displayed at the same time. Reference numeral 203 denotes a RGB color mixture ratio calculation unit for calculating a RGB color mixture ratio from the tristimulus values obtained from a measurement value on a screen in which R, G and B are displayed in the same gradation value at the same time and the XYZ-RGB conversion matrix generated by the XYZ-RGB conversion matrix generation unit 202. Reference numeral 204 denotes a correction data generation unit for generating the γ correction data from the calculated RGB color mixture ratio and a target characteristic of the γ correction.

The liquid crystal display apparatus 1000′ having this structure executes calibration action for the γ correction when an operation switch (not shown) is operated.

After the calibration action is executed, to measure an original characteristic of the liquid crystal display panel, brightness Y and chromaticities x, y are measured by a brightness and chromaticity measurement unit 30 under a control of the image signal control unit 24′ with a display of a measurement object color of R, G and B set as a maximum gradation value and a display of the other colors set as a minimum gradation value. Next, with all displays of R, G and B set as a minimum gradation value (black display), brightness Y and chromaticities x, y are measured with the brightness and chromaticity measurement unit 30.

Brightness Y and chromaticities x, y measured here are converted to each tristimulus values XYZ by the Yxy-XYZ conversion unit 201 and M⁻¹ explained in the first embodiment is generated by the XYZ-RGB conversion matrix generation unit 202.

Next, withall R, G and B displayed at a predetermined gradation value (=displayed in gray), the brightness Y and chromaticities x, y are measured with the brightness and chromaticity measurement unit 30 and converted to the tristimulus values by the Yxy-XYZ conversion unit 201. RGB color mixture ratio is calculated using M⁻¹ generated by the XYZ-RGB conversion matrix generation unit 202. By calculating this RGB color mixture ratio from the minimum gradation value up to the maximum gradation value of gray display over entire gradation regions, the change characteristic of each color mixture ratio of R, G, and B to the input gradation value is obtained.

The γ correction data is generated by the correction data generation unit 204 according to the change characteristic of each color mixture ratio of R, G and B to the input gradation value obtained in this way and a target characteristic for the γ correction generally set up by the target characteristic setting unit 21′ based on f(V)=Vγ with the input gradation value as V and stored in a memory unit (not shown) constituting the data conversion unit 4, 5, 6.

Next, the maximum gradation adjustment value determination unit 23′ determines a maximum gradation adjustment value based on a chromaticity set up by the target characteristic setting unit 21′ and a RGB color mixture ratio calculated using M⁻¹ generated by the XYZ-RGB conversion matrix generation unit 202 and set as an adjustment value of the maximum gradation adjustment unit 7, 8, 9 and then the calibration ends.

Here, as a target characteristic to be set up by the target characteristic setting unit 21′, it is permissible to build in plural characteristics and for a user to select one.

As described above, according to this embodiment, the liquid crystal display apparatus 1000′ enables γ correction and calibration of white balance to be performed independently and therefore, a change in display characteristic originating from aging of the V-T characteristic of the image display unit 1, 2, 3, which is a liquid crystal panel, can be adjusted by user easily at an arbitrary timing.

According to the present invention, no dispersion in chromaticity occurs in an intermediate gradation value, so that a display without any dispersion in chromaticity can be performed over all gradation regions. Further, the display can be executed at an arbitrary white balance without a necessity of plural correction data and without changing the correction data.

What is claimed is:

1. A correction data generating method of an image display apparatus having data conversion means for outputting digital data of corrected image signal with respect to digital data of each input image signal of R, G and B, comprising:
a first step of obtaining tristimulus values of each of R, G and B at a maximum gradation value or a gradation value near the maximum gradation value;
a second step of obtaining tristimulus values when gradation value of R, gradation value of G and gradation value of B are minimum gradation value;
a third step of obtaining tristimulus values when R, G and B are displayed at a gradation value between the maximum gradation value or the gradation value near the maximum gradation value and the minimum gradation value at the same time;
a generating step of generating a conversion matrix for converting XYZ, constituted of tristimulus values obtained by subtracting the tristimulus values obtained in said second step from the tristimulus values of each of R, G and B obtained in said first step, to a color mixture ratio of R, G, and B;
a calculating step of calculating a color mixture ratio of R, G and B from the generated conversion matrix and the tristimulus values obtained in said third step; and
a generating step of generating correction data from (i) change characteristic data corresponding to a relation between an input gradation value and a color mixture ratio of the R, G and B calculated corresponding to the input gradation value and (ii) a target gradation characteristic data corresponding to a relation between the input gradation value and brightness data corresponding to the input gradation value.

2. A correction data generating method of image display apparatus according to claim 1, wherein the gradation value near the maximum gradation value is smaller than the maximum gradation value and equal to or more than maximum gradation value x 0.95.

3. A correction data generating method of an image display apparatus according to claim 1, wherein said image display apparatus further comprises maximum gradation adjustment means for adjusting the maximum gradation value of digital data of the input image signal, said correction data generating method further comprising:
a setting step of setting a target chromaticity of white balance in white display;
a calculating step of calculating a color mixture ratio of R, G and B for obtaining the target chromaticity from the target chromaticity and the conversion matrix; and
a determining step of determining an adjustment value of said maximum gradation value adjustment means based on the calculated color mixture ratio of R, G and B for obtaining the target chromaticity.

4. A correction data generating method of an image display apparatus according to claim 1, further comprising:
after the correction data is generated corresponding to a plurality of regions in a display screen, extracting the correction data corresponding to a reference region in the plurality of regions; and
a generating step of generating gradation correction error data indicating an error between correction data corresponding to the reference region and correction data corresponding to other region.

5. A manufacturing method of an image display apparatus comprising:
providing an image display apparatus having data conversionmeans foroutputtingdigital dataof corrected image signal with respect to digital data of each input image signal of R, G and B; and
a setting step of setting a generated correction data in a memory of said data conversion means,
wherein said correction data is obtained by following steps,
a first step of obtaining tristimulus values of each of R, G and B at a maximum gradation value or a gradation value near the maximum gradation value;
a second step of obtaining tristimulus values when gradation value of R, gradation value of G and gradation value of B are minimum gradation value;
a third step of obtaining tristimulus values when R, G and B are displayed at a gradation value between the maximum gradation value or the gradation value near the maximum gradation value and the minimum gradation value at the same time;
a generating step of generating a conversion matrix for converting XYZ, constituted of tristimulus values obtained by subtracting the tristimulus values obtained in said second step from the tristimulus values of each of R, G and B obtained in said first step, to a color mixture ratio of R, G, and B;
a calculating step of calculating a color mixture ratio of R, G and B from the generated conversion matrix and the tristimulus values obtained in said third step; and
a generating step of generating correction data from (i) change characteristic data corresponding to a relation between an input gradation value and a color mixture ratio of the R, G and B calculated corresponding to the input gradation value and (ii) a target gradation characteristic data corresponding to a relation between the input gradation value and brightness data corresponding to the input gradation value.
